(19) United States
(12) Patent Application Publication
(10) Pub. No.: US 2006/0160579 A1
(43) Pub. Date: Jul. 20, 2006

(54) Ring tone suites

(76) Inventor: Michael J. Ure, Cupertino, CA (US)

Correspondence Address: Michael J. Ure, 10518 Phil Place, Cupertino, CA, 95014, US

(21) Appl. No.: 11/038,823

(22) Filed: Jan. 19, 2005

(51) Int. Cl. H04B 1/38; H04M 1/00

(52) U.S. Cl. 455/567

(57) ABSTRACT

The present invention, generally speaking, provides for a “ring tone suite” in which multiple related ring tones are downloaded together, and different ones of those ring tones may be used to announce successive calls. In one embodiment, the ring tones are “themed,” and have informational and/or entertainment content distinct from that of a simple melody. The ring tones may be updated over-the-air or over-the-wire on a regular basis. For example, each ring tone may be a sports highlight excerpted from a broadcast of a recent sporting event. Numerous other examples of ring tone suites will be readily apparent, for example non-sports news highlights, quotable quotes, etc.

### BACKGROUND OF THE INVENTION

Downloading of customized ring tones for cell phones has become a billion dollar business. User enthusiasm for custom ring tones suggests that further variety in custom ring tones may be well-received.

### SUMMARY

The present invention, generally speaking, provides for a “ring tone suite” in which multiple related ring tones are downloaded together, and different ones of those ring tones may be used to announce successive calls. In one embodiment, the ring tones are “themed,” and have informational and/or entertainment content distinct from that of a simple melody. The ring tones may be updated over-the-air or over-the-wire on a regular basis.

### BRIEF DESCRIPTION OF THE DRAWING

FIG. 1 is a diagram of a system in which the present invention may be used.

### DETAILED DESCRIPTION

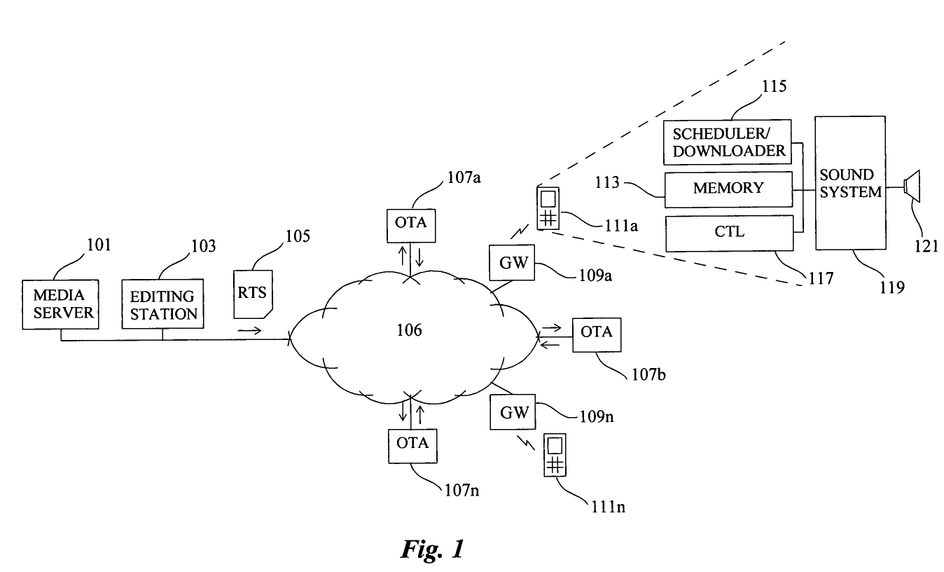

Referring now to FIG. 1, a diagram is shown of a system in which the present invention may be used. The system is preferably internet-based. At the location of a service provider, a media server 101 stores media segments from which a ring tone suite will be created. An editing station 103 is used to create the ring tone suite 105, which is then distributed (over the internet 106, for example) to multiple servers, including for example OTA—over-the-air—servers 107a-107n. Each OTA server communicates with a gateway (109a-109n) that enables phones (111a-111n) to download content from the OTA server through the gateway in a manner know in the art.

Although not illustrated, wired phones may also access servers (through suitable gateways, for example) to download ring tone suites. The user interface for such downloading may be the familiar voice-message/touch tone interface.

Details of one of the phones are shown in exploded view. The phone includes, among various other elements, memory 113, a scheduler/downloader 115, control logic 117, a sound system 119 and a speaker 121. The scheduler/downloader causes a ring tone suite to be downloaded and stored in memory. The control logic controls play out of individual ones of the ring tones of the ring tone suite.

The phone (which may be wired or wireless) may be similar to existing phones. Existing phones provide for the storage of multiple (unrelated) ring tones and manual selection of an active ring tone. In accordance with one aspect of the present invention, multiple thematically-related ring tones are stored together. The phone is programmed to automatically sequence through the ring tones as successive calls are received.

For example, each ring tone may be a sports highlight excerpted from a broadcast of a recent sporting event. In the case of a basketball game, for example, at the end of a particular day of play, audio highlights may be assembled in the form of a ring tone suite and stored on a server (e.g., an OTA—over-the-air—server) for download to phones. Phones may be programmed to automatically access the server on a scheduled basis (including possibly powering up on a schedule basis for this purpose), or at a convenient time at or after power-up on a particular day, to download the ring tone suite. Alternatively, ring tones may be downloaded individually or in smaller groups on an as-needed basis. After the ring tone suite (or a portion thereof) has been downloaded, the phone sequences through the ring tones as successive calls are received.

Numerous other examples of ring tone suites will be readily apparent, for example non-sports news highlights, quotable quotes, etc.

As the user hears the different ring tones, the user may wish to know more about the subject of a particular ring tone. An option may be provided to enable the user to select a particular ring tone to cause a corresponding video clip (e.g., a dunk or other highlight) to be downloaded or otherwise accessed and displayed.

A user preference setting may be provided allowing the user to set how many times a ring tone is played before it becomes stales and is no longer played. A different ring tone from the ring tone suite or a conventional default ring tone may then be played in its stead.

It will be appreciated by those of ordinary skill in the art that the invention may be embodied in other specific forms without departing from the spirit or essential scope thereof. The disclosed embodiments are intended in all respects to be illustrative and not restrictive. The scope of the invention is defined by the appended claims rather than the foregoing description, and all modifications and changes that fall within the scope thereof are intended to be embraced therein.

What is claimed is:

1. A method of call annunciation comprising:
assembling a ring tone suite of multiple thematically-related ring tones;
storing the ring tone suite in a phone; and
automatically playing different ones of the ring tones to announce different calls.

2. The method of claim 1, further comprising automatically replacing the ring tone suite with a different ring tone suite on a periodic basis.

3. The method of claim 1, wherein ring tones of the ring tone suite relate to sports highlights.

4. The method of claim 1, further comprising receiving a user selection selecting a particular ring tone and displaying a still video or motion video clip relating to the particular ring tone.

5. A method of providing information, comprising:
assembling a ring tone suite of multiple thematically-related ring tones;
storing the ring tone suite on a server; and
receiving from a particular phone periodic requests to download the ring tone suite.

6. The method of claim 5, wherein the period requests are made on a weekly or more frequent basis.

7. The method of claim 5, wherein ring tones of the ring tone suite relate to sports highlights.

8. The method of claim 5, further comprising storing still videos or motion video clips relating to the particular ring tones and receiving requests to download the still videos or motion video clips.

9. A phone comprising:
a scheduler/downloader for downloading a ring tone suite; and
control logic for controlling play out of ring tones within the ring tone suite.
